(19) United States
(12) Patent Application Publication
(10) Pub. No.: US 2017/0054168 A1
(43) Pub. Date: Feb. 23, 2017

(54) SOLID OXIDE FUEL CELL SYSTEM

(71) Applicant: LG Fuel Cell Systems, Inc., North Canton, OH (US)

(72) Inventors: John R. Budge, Beachwood, OH (US); Gerard D. Agnew, Uttoxeter (GB)

(21) Appl. No.: 15/240,766

(22) Filed: Aug. 18, 2016

Related U.S. Application Data
(60) Provisional application No. 62/206,649, filed on Aug. 18, 2015.

(51) Int. Cl. H01M 8/0612; H01M 8/04082; H01M 8/04089; H01M 8/1016; H01M 8/22

(52) U.S. Cl. CPC H01M 8/0612; H01M 8/1016; H01M 8/22; H01M 8/04097; H01M 8/04201; H01M 2300/0071

(57) ABSTRACT

In some examples, a solid oxide fuel cell system including a solid oxide fuel cell; an ejector, wherein the ejector is configured to receive a fuel recycle stream from a fuel side outlet of the solid oxide fuel cell and also receive a primary fuel stream, wherein the ejector is configured such that the flow of the primary fuel stream draws the fuel recycle stream into the ejector and mix the fuel recycle and primary fuel stream to form a mixed fuel stream including methane and higher hydrocarbons; and a higher hydrocarbon reduction unit configured to receive the mixed fuel stream from the ejector and remove a portion of the higher hydrocarbons via a catalytic conversion process to form a reduced higher hydrocarbon fuel stream, wherein a fuel side inlet of the solid oxide fuel cell is configured to receive the reduced higher hydrocarbon fuel stream from a reduction unit.

This application claims the benefit of U.S. Provisional Application No. 62/206,649 filed Aug. 18, 2015, which is incorporated herein by reference in its entirety.

### TECHNICAL FIELD

The disclosure generally relates to solid oxide fuel cell systems.

### BACKGROUND

Fuel cells and fuel cell systems, such as, e.g., solid oxide fuel cell and solid oxide fuel cell systems remain an area of interest. Some existing systems have various shortcomings, drawbacks, and disadvantages relative to certain applications. Accordingly, there remains a need for further contributions in this area of technology.

### SUMMARY

In one example, the disclosure relates to a solid oxide fuel cell system comprising a solid oxide fuel cell including at least one electrochemical cell, a fuel side inlet, a fuel side outlet, an oxidant side inlet and oxidant side outlet; an ejector including a first ejector inlet, second ejector inlet, and ejector outlet, wherein the ejector is configured to receive a fuel recycle stream from the fuel side outlet of the solid oxide fuel cell via the first ejector inlet, wherein the ejector is configured to receive a primary fuel stream via the second ejector inlet, wherein the ejector is configured such that the flow of the primary fuel stream draws the fuel recycle stream into the ejector via the first ejector inlet, wherein the ejector is configured to mix the fuel recycle stream and primary fuel stream to form a mixed fuel stream including methane and higher hydrocarbons; and a higher hydrocarbon reduction unit configured to receive the mixed fuel stream from the ejector outlet and remove at least a portion of the higher hydrocarbons of the mixed fuel stream via a catalytic conversion process to form a reduced higher hydrocarbon fuel stream, wherein the fuel side inlet is configured to receive the reduced higher hydrocarbon fuel stream from a reduction unit outlet, wherein the at least one electrochemical cell is configured to generate electricity from the hydrogen in the reduced higher hydrocarbon fuel stream via an electrochemical process with a oxidant stream received by the solid oxide fuel cell via the oxidant side inlet, and wherein the reduced higher hydrocarbon fuel stream forms the fuel recycle stream exiting the solid oxide fuel cell via the fuel side outlet.

In another example, the disclosure is directed to a method comprising generating electricity via a solid oxide fuel cell system, the fuel cell system comprising a solid oxide fuel cell including at least one electrochemical cell, a fuel side inlet, a fuel side outlet, an oxidant side inlet and oxidant side outlet; an ejector including a first ejector inlet, second ejector inlet, and ejector outlet, wherein the ejector is configured to receive a fuel recycle stream from the fuel side outlet of the solid oxide fuel cell via the first ejector inlet, wherein the ejector is configured to receive a primary fuel stream via the second ejector inlet, wherein the ejector is configured such that the flow of the primary fuel stream draws the fuel recycle stream into the ejector via the first ejector inlet, wherein the ejector is configured to mix the fuel recycle stream and primary fuel stream to form a mixed fuel stream including methane and higher hydrocarbons; and a higher hydrocarbon reduction unit configured to receive the mixed fuel stream from the ejector outlet and remove at least a portion of the higher hydrocarbons of the mixed fuel stream via a catalytic conversion process to form a reduced higher hydrocarbon fuel stream, wherein the fuel side inlet is configured to receive the reduced higher hydrocarbon fuel stream from a reduction unit outlet, wherein the at least one electrochemical cell is configured to generate electricity from the hydrogen in the reduced higher hydrocarbon fuel stream via an electrochemical process with a oxidant stream received by the solid oxide fuel cell via the oxidant side inlet, and wherein the reduced higher hydrocarbon fuel stream forms the fuel recycle stream exiting the solid oxide fuel cell via the fuel side outlet.

The details of one or more embodiments of the disclosure are set forth in the accompanying drawings and the description below. Other features, objects, and advantages of the disclosure will be apparent from the description and drawings, and from the claims.

### BRIEF DESCRIPTION OF DRAWINGS

The description herein makes reference to the accompanying drawings wherein like reference numerals refer to like parts throughout the several views.

FIG. 1 is a schematic diagram illustrating an example fuel cell system.

FIG. 2 is a plot illustrating the results of an experiment carried out to evaluate one or more aspects of the disclosure.

FIGS. 3A and 3B are photographs showing examples of ceramic and metallic monoliths.

FIG. 4 is a photograph showing two ceramic pieces used in an experiment carried out to evaluate one or more aspects of the disclosure.

### DETAILED DESCRIPTION

Solid oxide fuel systems may be employed to generate electricity using one or more electrochemical cells. The design of fuel cell systems operating with hydrocarbon feed stocks, such as, e.g., natural gas, must take into account the potential for carbon formation in the fuel processing components and/or fuel cell stack. For example, carbon formation may occur at elevated temperatures via hydrocarbon cracking (Reaction 1) or from the Boudouard reaction (Reaction 2) as follows:

CₓH₂ₓ₊₂→xC+(x+1)H₂, where x≧2 (Reaction 1)

2CO→C+CO₂ (Reaction 2)

Carbon deposition in the system may also adversely affect fuel cell performance by blocking gas flow paths, promoting metal dusting, fouling catalytic fuel cell components, and promoting anode delamination in the fuel cell stack.

As will be described in further detail herein, examples of the disclosure may be employed to reduce the potential for carbon formation through the use of a higher hydrocarbon reduction unit configured to preferentially convert hydrocarbons with two or greater carbon atoms (referred to herein as “higher hydrocarbons”), such as, e.g., ethane, propane, butane, pentane, and so forth, present in the gaseous feed stream to methane in the presence of hydrogen and steam (Reaction 3):

CₓH₂ₓ₊₂+(x−1)H₂→xCH₄, where x≧2 (Reaction 3)

Since methane, steam, hydrogen, carbon monoxide and carbon dioxide are also present in the feed stream, other conversion processes may also occur to extents limited by the reaction kinetics, thermodynamics and heat transfer from the surroundings (Reactions 4-7)

CH₄+H₂O [symbol] CO+3H₂ (Reaction 4)

CO+H₂O [symbol] CO₂+H₂ (Reaction 5)

CO+3H₂ [symbol] CH₄+H₂O (Reaction 6)

CₓH₂ₓ₊₂+xH₂O [symbol] (2x+1)H₂+xCO (Reaction 7)

The higher hydrocarbon reduction unit provides a gas stream substantially free of higher hydrocarbons and comprised primarily of methane, hydrogen, carbon dioxide and carbon monoxide substantially immediately or relatively soon after injection into the cell system cycle and prior to being introduced to the anode side of a solid oxide fuel cell. Methane, carbon monoxide and hydrogen are much more stable at higher temperatures and less prone to thermal cracking than the higher hydrocarbons. In some examples, about 80% or greater, e.g., about 90% or greater, 95% or greater, or substantially all of the higher hydrocarbons are removed from the gaseous hydrocarbon feed by the higher hydrocarbon reduction unit prior to being introduced to the anode (fuel) side of a solid oxide fuel cell. In some examples, prior to introduction into the anode side of the solid oxide fuel cell, the fuel stream exiting the hydrocarbon reduction unit may be further processed in a steam reformer to reduce the methane content of the gas partially or to the equilibrium limit according to Reactions 4-5.

The gaseous hydrocarbon stream fed to the higher hydrocarbon reduction unit may be a mixture of a primary fuel stream (e.g., a natural gas stream) and a fuel recycle stream exiting a solid oxide fuel cell of the system from the anode (fuel) side. An ejector (also referred to as an eductor) may be employed to mix the primary fuel stream and fuel recycle stream. The ejector may be configured such that the flow of the primary fuel stream draws the recycle fuel stream into the ejector (e.g., without needing to pump the recycle stream into the ejector), where the recycle fuel stream is mixed with the primary fuel stream. The fuel recycle stream may be at a relatively high temperature due to the high operating temperature of the solid oxide fuel cell. Thus, the fuel recycle stream may advantageously serve to increase the temperature of the primary fuel stream when mixed in the ejector. Moreover, the recycle fuel stream may also include a high concentration of steam (e.g., about 30 to about 60% steam). Thus, the recycle fuel stream advantageously provides heat and a steam source for the higher hydrocarbon reduction and steam reforming units downstream of the ejector.

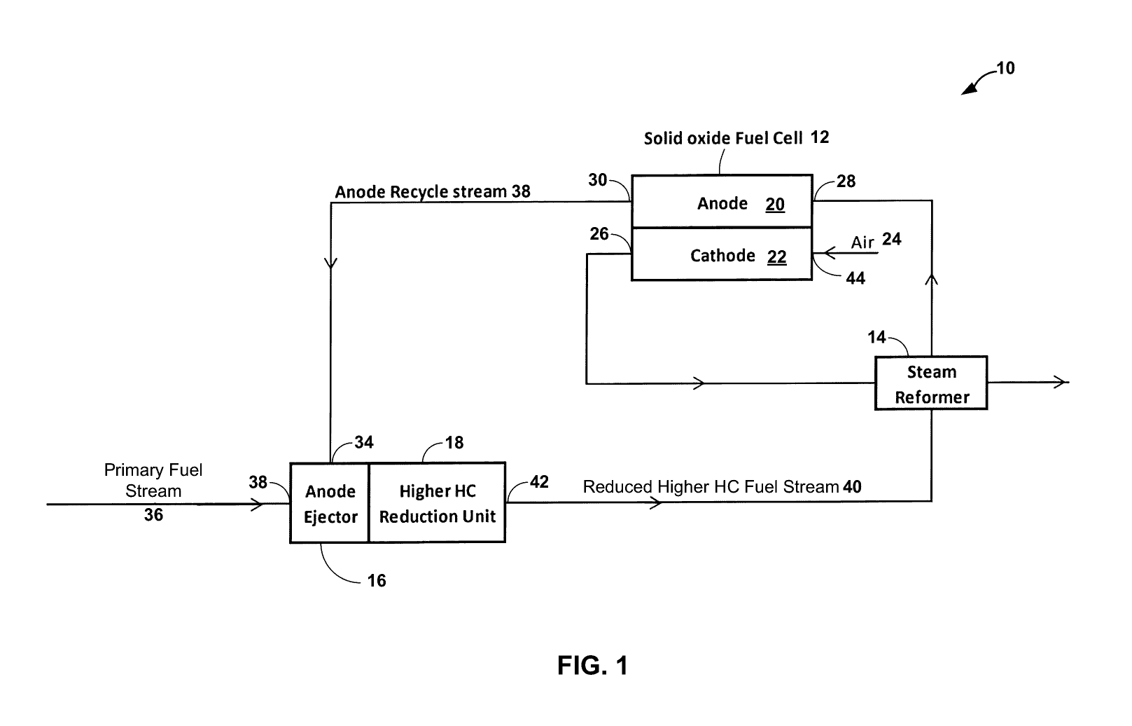

FIG. 1 is a schematic diagram illustrating an example solid oxide fuel cell system 10 in accordance with an embodiment of the present disclosure. Fuel cell system 10 includes solid oxide fuel cell stack 12, optional steam reformer 14, anode ejector 16, and higher hydrocarbon (“HC”) reduction unit 18.

Solid oxide fuel cell 12 may include one or more electrochemical cells, e.g., in the form of a fuel cell stack, which are used to generate electricity via chemical reaction. Any suitable solid oxide fuel cell system including one or more electrochemical cells may be utilized in the present disclosure. Suitable examples include those examples described in U.S. Patent Application Publication No. 2003/0122393 to Liu et al., published May 16, 2013, the entire content of which is incorporated by reference.

The electrochemical cells of solid oxide fuel cell stack 12 include an anode, cathode, and electrolyte, and the solid oxide fuel cell stack 12 includes anode (fuel) side 20 and cathode (oxidant) side 22. During the operation of fuel cell system 12, an oxidant stream (e.g., in the form of air 24 as labelled in FIG. 1) may be fed to cathode side 22 via oxidant side inlet 44, which exits cathode side 24 of fuel cell 12 via oxidant side outlet 26. Similarly, a fuel stream including hydrogen may be fed to anode side 20 via fuel side inlet 28, which exits anode side 24 of fuel cell 12 via fuel side outlet 30. The electrochemical reaction of hydrogen with oxide ions at the anode (H₂+O²⁻→H₂O+2e⁻) generates the majority of the steam in anode recycle stream 38 that is used by the fuel processing components. As shown in FIG. 1, system 10 is configured such that the fuel stream entering anode side 20 via inlet 28 may be reduced higher HC fuel stream 32 generated by higher HC reduction unit 18.

Fuel side outlet 30 may be in fluid connection with first ejector inlet 34 such that the stream exiting anode side outlet 30 (labelled and referred to as anode recycle stream 38 in FIG. 1) enters ejector 16 after exiting solid oxide fuel cell 12. Additionally, primary fuel stream 36 (e.g., a natural gas stream) enters ejector 16 separately via second ejector inlet 38. Ejector 16 may be configured such that the flow of primary fuel stream 36 into ejector 16 draws anode recycle stream 38 into ejector 16. In this sense, first ejector inlet 34 may be referred to as a suction inlet and second ejector inlet 38 may be referred to as a motive inlet. The flow of primary fuel stream 36 may for example be generated by connecting the ejector to a compressed fuel source via piping with an in-line valve being used to adjust the gas flow rate, and may be considered the motive fluid with regard to the operation of ejector 16.

Ejector 16 may also be configured such that anode recycle stream 38 is mixed with primary fuel stream 36 upon being drawn into ejector 16 via first inlet 34. The ejector design should preferably promote rapid mixing of the fluid streams and minimize contact of the hydrocarbon fuel with the hot surfaces of the ejector and its diffuser during the mixing process. Ejector 16 is fluidly coupled to higher HC reduction unit 18 such that the mixed fuel stream from the ejector is fed via one or more outlets (not shown in FIG. 1) to a higher HC reduction unit 18. Conventional metal or ceramic piping may be used to connect the ejector to the higher hydrocarbon reduction unit. When metal tubing is used, the inner metal surface of the tubing is preferably coated with a ceramic material that prevents the higher hydrocarbons present in the gas stream from contacting the hot metal surfaces. Preferably, ejector 16 should be configured such that the mixed fuel stream fed to higher HC reduction unit 18 is substantially uniform compositions of anode recycle stream 38 and primary fuel stream 36.

Ejector 16 may be any suitable ejector or eductor configured to operate as described herein. Example ejectors or eductors may include one or more of the examples described in U.S. Pat. No. 6,902,840 to Blanchet et al., U.S. Pat. No. 5,441,821 to Merritt et al., and/or European Patent Application Publication No. 2565970. The entire content of each of these documents is incorporated herein by reference. Other example ejectors or eductors are also contemplated.

Anode recycle stream 38 and primary fuel stream 36 may have any suitable composition when entering anode ejector 16. In some examples, anode recycle stream 38 may include steam, methane, carbon monoxide, carbon dioxide, nitrogen, and/or hydrogen. For example, anode recycle stream 38 may include about 30 to about 70 vol.-% steam (preferably about 45 to about 55 vol.-% steam); about 0 to about 1 vol.-% methane (preferably about 0 to about 0.05 vol.-% methane); about 10 to about 40 vol.-% carbon monoxide plus hydrogen (preferably about 20 to about 30 vol.-% carbon monoxide plus hydrogen); and about 10 to about 40 vol. % carbon dioxide plus nitrogen (preferably about 20 to about 30 vol.-% carbon dioxide plus nitrogen). The precise composition will be dependent on, inter alia, the recycle ratio, i.e. the ratio of the anode recycle rate to the primary fuel rate, the operating temperature of the solid oxide fuel cell and the fuel utilization. In some examples, primary fuel stream 36 may be a desulfurized natural gas fuel stream including hydrocarbons (such as, e.g., methane and higher hydrocarbons) as well as other components such as, e.g., carbon dioxide and nitrogen. For example, primary fuel stream 36 may include greater than or equal to about 50 vol.-% methane (preferably about 75 to about 98 vol. %); about 0.1 to about 40 vol. % higher hydrocarbons; about 0 to about 15 vol. % carbon dioxide plus nitrogen; and preferably less than about 5 vol. % water. Example fuel compositions other than those described herein are contemplated. These fuels include liquefied petroleum gas or synthetic natural and fuel blends tailored to provide gas mixtures having desired heat contents. While sulfur-containing fuels can be used with sulfur tolerant fuel cell systems and fuel processing components, it is usually advantageous to desulfurize the fuel. Methods for sulfur removal from hydrocarbon fuels include: a) conventional hydro-desulfurization processing (e.g. as described in U.S. Pat. No. 5,010,049 to Villa-Gracia et al.), b) the use of passive sorbents which adsorb the sulfur compounds present (e.g. as described in U.S. Patent Application publication US20130078540 by Ratnasamy et al.), and c) selective catalytic sulfur oxidation (SCSO) and then capturing the sulfur oxidation products (e.g. as described in U.S. Pat. No. 7,074,375 to Lampert). Each of the above listed references are incorporated herein in their entirety.

In some examples, the temperature of anode recycle stream 38 when entering ejector 16 may be much greater than the temperature of primary fuel stream 36 when entering ejector 16. Advantageously, in some examples, the higher temperature of anode recycle stream 38 serves to increase the temperature of primary fuel stream 36, e.g., to pre-heat primary fuel stream 36 prior to higher HC reduction unit 18 and anode side 20. In some examples, the temperature of anode recycle stream 38 when entering ejector 16 may be greater than about 500 degrees Celsius (C), and preferably greater than about 650 degrees C., and more preferably from about 750 degrees C. to about 950 degrees C. In some examples, the temperature of primary fuel stream 36 when entering ejector 16 may be greater than about 50 degrees C., and preferably greater than about 75 degrees C., and more preferably from about 90 to about 150 degrees C. After mixing in ejector 16, the temperature of the mixed anode recycle stream 38 and primary fuel stream 36 entering higher HC reduction unit 18 may be greater than about 400 degrees C., and preferably greater than about 500 degrees C., and more preferably between about 600 and about 750 degrees C.

The temperature and overall composition of the mixed stream entering higher HC reduction unit 18 may depend on the volumetric flow rates of primary fuel stream 36 and anode recycle stream 38 entering ejector 16 relative to each other. In some examples, the ratio of the volumetric flow rate of anode recycle stream 38 to the volumetric flow rate of primary fuel stream 36 may be approximately 2:1 or greater, e.g., approximately 4:1 or greater. In some examples related to an approximately 30 k-We fuel cell power stack operating on natural gas, the volumetric flow rate of anode recycle stream 38 may be about 150 SLM or greater, and preferably about 200 to about 300 SLM. The volumetric flow rate of primary fuel stream 36 may be about 25 SLM or greater and preferably about 40 to about 60 SLM. Further, in some examples, the ratio of the anode-recycle to primary-fuel rates (i.e. recycle ratio) should be greater than about 2 and preferably greater than about 4 to ensure that the anode recycle stream contains sufficient steam for efficient processing in the downstream higher HC reduction unit and optional steam reforming unit.

Based on the composition of anode recycle stream 38 and primary fuel stream 36, the mixed fuel stream from ejector 16 may include methane as well as higher hydrocarbons, such as, e.g., ethane, propane, butane, pentane, and so forth. The higher hydrocarbons in the mixed stream may primarily originate from primary fuel stream 36, particularly when fuel stream 36 is in the form of a natural gas stream (although primary fuel streams containing higher hydrocarbons other than natural gas streams, e.g. liquefied petroleum gas and biogas, are contemplated). Typical gas steam compositions may range from about (vol.-%): about 5 to about 35% methane, about 0.01 to about 15% higher hydrocarbons, about 10 to about 40% carbon dioxide plus nitrogen, about 20% to about 60% steam, and about 10 to about 35% hydrogen plus carbon monoxide. Higher HC reduction unit 18 may be configured to reduce the amount of higher hydrocarbons in the mixed fuel stream received from ejector 16 by converting at least a portion of the higher hydrocarbons from ejector according to Reaction 3. For example, higher HC reduction unit 18 may be configured to convert at least 60% of the higher hydrocarbons and preferably at least 80% according to reaction 3 described above.

The catalyst compositions suitable for use in higher HC reduction unit 18 include at least one Group VIII metal and more preferably at least one Group VIII noble metal. The Group VIII noble metals include platinum, palladium, rhodium, iridium or a combination thereof. Catalysts comprising rhodium and or platinum are particularly preferred. In one form, the catalyst is supported on a carrier. Suitable carriers are known in the art and include refractory oxides such as silica, alumina, titania (titanium dioxide), zirconia and tungsten oxides, and mixtures thereof. Mixed refractory oxides comprising at least two cations may also be employed as carrier materials for the catalyst. In other embodiments, the catalyst may be supported on any convenient solid and/or porous surface or other structure. In still other embodiments, the catalyst may not be supported on a carrier or any other structure. In some embodiments, the catalyst also includes promoter elements to improve catalyst activity and durability and to suppress carbon formation. Examples of promoter elements include, but are not limited to, elements selected from Groups IIa-VIIa, Groups Ib-Vb, Lanthanide Series and Actinide Series (e.g. using the old International Union of Pure and Applied Chemistry (IUPAC) version of the periodic table). Promoters such as magnesia, ceria and baria may suppress carbon formation on the catalyst.

The catalytically active metal and optional promoter elements may be deposited on the carrier by techniques known in the art. In one form, the catalyst is deposited on the carrier by impregnation, e.g., by contacting the carrier material with a solution of the catalyst metals, followed by drying and calcining the resulting material. The catalyst may include the catalytically active metals in any suitable amount that achieves the desired higher hydrocarbon conversion. In some examples, the catalyst comprises the active metals in the range of 0.01 to 40 wt-%, preferably from 0.1 to 15 wt-%, and more preferably 0.5 to 5 wt-%. Promoter elements may be present in amounts ranging from 0.01 to about 10 wt-% and preferably 0.1 to 5 wt-%. Embodiments of the present invention may also include greater or lesser percentages of active metals and/or promoter elements.

In various embodiments, the higher HC reduction unit 18 may be configured to provide any suitable reaction regime that provides contact between the catalyst and the reactants during the higher HC reduction process. In one form, higher HC reduction unit 18 is a fixed bed reactor, in which the catalyst is retained within a reaction zone in a fixed arrangement. In one form, catalyst pellets are employed in the fixed bed regime, e.g., retained in position by conventional techniques. In other embodiments, other reactor types and reaction regimes may be employed, e.g., such as a fluid bed reactor, where the catalyst is present as small particles and fluidized by the stream of process gas.

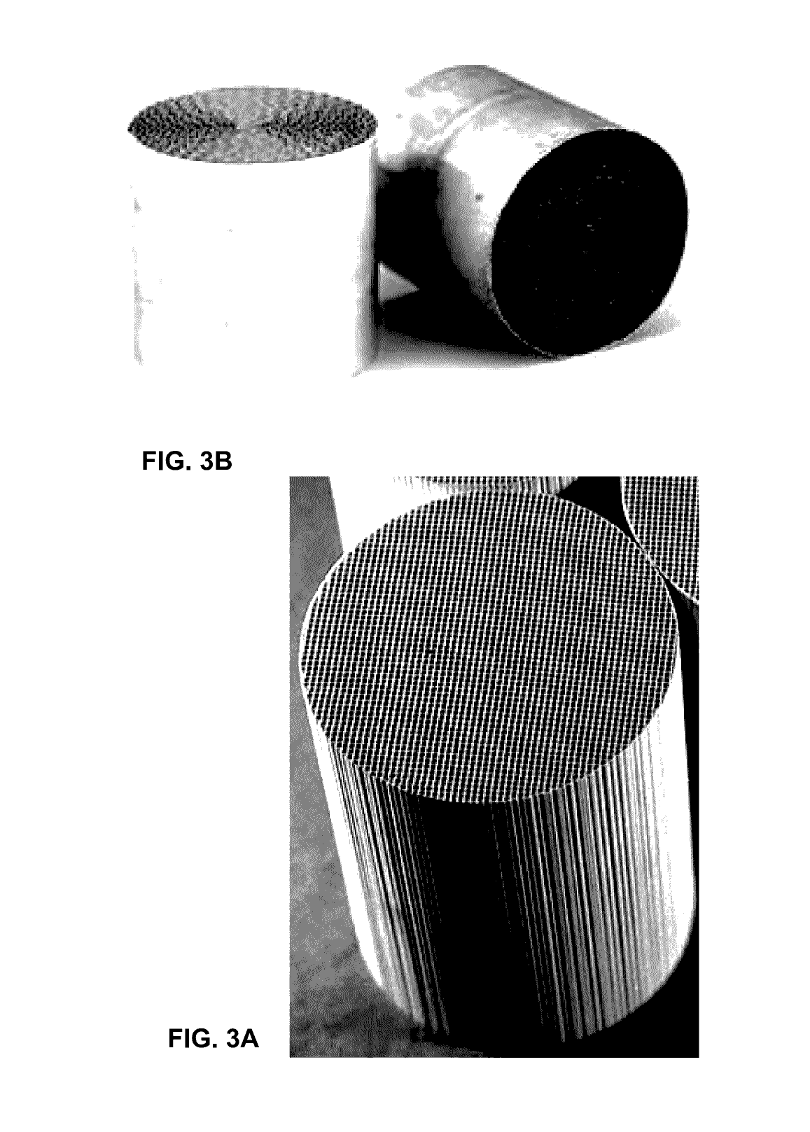

In some embodiments, the fixed bed arrangement may take other forms, e.g., wherein the catalyst is disposed on a monolithic structure. For example, some typical embodiments may include catalyst that is wash-coated onto the monolithic structure. Suitable monolithic structures include refractory oxide monoliths, ceramic foams and metallic monoliths and foams, as well as other structures formed of refractory oxides, ceramics and/or metals. A preferred type of monolithic structure is one or more monolith bodies having a plurality of finely divided flow passages extending therethrough, e.g., a honeycomb, although other types of monolithic structures may be employed. The monolithic supports may be fabricated from one or more metal oxides, for example alumina, silica-alumina, alumina-silica-titania, mullite, cordierite, zirconia, zirconia-spinel, zirconia-mullite, silcon carbide, etc. The monolith structure may have a cylindrical configuration with a plurality of parallel gas flow passages of regular polygon cross-section extending therethrough. The gas flow passages may be sized to provide from about 50 to 1500 gas flow channels per square inch. Other materials, size, shapes and flow rates may also be employed, including flow passages having greater or smaller sizes than the ranges mentioned herein. For example, a monolithic structure may be fabricated from a heat and oxidation resistant metal such as stainless steel or the like. Monolith supports may be made from such materials, e.g., by placing a flat and a corrugated sheet one over the other and rolling the stacked sheets into a tubular configuration about an axis to the corrugations to provide a cylindrical structure having a plurality of fine parallel gas flow passages. The flow passages may be sized for the particular application, e.g., from about 200 to 1200 per square inch of end face area of the tubular roll. The catalytic materials may be coated onto the surface of the honeycomb by one or more of various known coating techniques. FIGS. 3A and 3B are photographs showing examples of suitable cylindrical ceramic and metallic monoliths, respectively.

The precise operating parameters for higher HC reduction unit 18 may be dependent on the fuel cell system configuration, but example operating parameters may range from about 1 to about 15 bar, about 400 to about 750 degrees Celsius, a Gas Hourly Space Velocity (GHSV) of about 5000 to 200,000 h⁻¹ and steam-to-hydrocarbon feed ratios (calculated on a C-1 basis) of about 1.5 to about 4 or higher. In some examples, the system may be configured to give less than about 30% methane conversion, e.g., less than about 20%, less than 10%, and preferably less than 5% methane conversion, with substantially complete higher hydrocarbon conversion. Higher HC reduction unit 18 may be external to solid oxide fuel cell stack 12 and may be configured to allow some heat transfer between the unit and its surroundings.

In some examples, higher HC reduction unit 18 may be configured to remove about 80 percent or greater, e.g., about 85 percent or greater, about 90 percent or greater, or preferably 95 percent or greater, of the higher hydrocarbons from the mixed fuel stream entering the higher HC reduction unit 18 from ejector 16. In some examples, the concentration of higher hydrocarbons in reduced higher HC fuel stream 40 following conversion by higher HC reduction unit 18 may be about 5 vol.-% or less, e.g., about 1 vol.-% or less and preferably about 0.3 vol.-% or less.

In some examples, higher HC reduction unit 18 may operate at a temperature of greater than or equal to about 400 degrees Celsius, such as e.g., about 500 degrees Celsius to 600 degrees Celsius, or preferably greater than or equal to about 650 degrees Celsius. In some examples, heat is added to higher HC reduction unit 18 to operate at the preferred temperature. Alternatively, the mixed fuel stream from ejector 16 may enter higher HC reduction unit 18 at such an elevated temperature due to the relatively high temperature at which anode recycle stream 38 enters ejector 16 and mixes with primary fuel stream 36, as described above.

As noted above, in higher HC reduction unit 18, the higher hydrocarbons may react at elevated temperatures according to Reaction 3 in the presence of a catalyst to reduce the amount of higher hydrocarbons in the mixed fuel stream exiting ejector 16. Advantageously, all of the steam required for the reactions in the higher HC reduction unit 18 and/or optional downstream steam reformer, may be supplied by the steam already contained in anode recycle stream 38 when exiting the anode side of solid oxide fuel cell 12. This eliminates the need for a separate source of steam to be supplied for higher HC reduction unit 18 to reduce the concentration of higher hydrocarbons in the mixed fuel stream supplied from ejector 16.

In some examples, the steam present in anode recycle stream 38 may be generated completely within the anode loop cycle of system 10 with substantially no additional water (e.g., no additional water) being added from an external source. For example, substantially no additional water (e.g., no additional water) may be added from an external source to anode recycle stream 38 between fuel side outlet 30 and ejector inlet 34, within ejector 16 beyond the relatively small amount of water (e.g., less than 5 vol. %) that may be present in the primary fuel stream 36 when entering ejector 16 (e.g., due to SCSO processing of the primary fuel stream 36 prior to entering ejector 16), and within higher HC reduction unit 18. Additionally, substantially no additional water (e.g., no additional water) may be added from an external source to reduced higher HC fuel stream 40 between outlet 42 and optional steam reformer unit 14, within optional steam reformed unit 14, and the outlet stream exiting steam reformer unit 14 and anode side inlet 28. Substantially no water (e.g., no additional water) may be added from an external source to anode side 20 of fuel cell 12.

As described above, the higher HC reduction unit 18 may be used to reduce the concentration of higher hydrocarbons in the fuel and in any subsequent steam reformation process, the remaining hydrocarbons may be converted to carbon monoxide and hydrogen in the presence of a catalyst, for use in the fuel cell. In fuel cell systems where fuel reforming is carried out in the fuel cell stack, the stream exiting the higher HC reduction unit 18 may be fed directly to the fuel cell stack. The inventive process described herein offers several advantages over conventional pre-reforming processes for higher hydrocarbon removal; these pressurized processes require steam generation, use relatively large adiabatic reactors (GHSV ˜3000 h⁻¹) and operate at temperatures around 450 degrees Celsius. Further adjustments in fuel composition and preheating may then be needed for subsequent high temperature steam reforming and use in the fuel cell stack.

Referring still to FIG. 1, reduced higher HC fuel stream 40 may exit higher HC reduction unit 18 via outlet 42, e.g., once the concentration of higher hydrocarbons in the mixed fuel stream from ejector 16 has been reduced to a desired level. Outlet 42 is in fluid connection with anode side inlet 28 of the fuel cell 12 via a stream reformer unit 14. Steam reformer 14 may be configured to modify the composition of reduced higher HC fuel stream 40 exiting reduced higher HC fuel stream 40. The steam reformer unit 14 converts the hydrocarbons (predominantly methane) in the reduced higher HC fuel stream 40 to hydrogen and carbon monoxide (Reaction 4) for use in the operation of fuel cell 12 to generate electricity. Since methane steam reforming is endothermic, heat from the cathode exhaust stream 26 is used to drive the process to near completion. In a preferred embodiment, steam reformer 14 is configured as a heat exchanger, with cathode exhaust stream 26 passing through the hot-side channels of the heat exchanger and reduced higher HC fuel stream 40 passing through cold-side channels of the heat exchanger which also contain a catalyst for steam reforming.

In some examples, reduced higher HC fuel stream 40 may exit higher HC reduction unit 18 with a composition desired for a fuel stream used by fuel cell 12 such that reduced higher HC fuel stream 40 is fed to anode inlet 28 without further modifying the content of the stream. This approach is particularly well suited for fuel stacks that are designed for in-stack reforming. With in-stack reforming, Reaction 4 is carried out inside the fuel cell stack, generating hydrogen and carbon monoxide in close proximity to the electrochemical cells. In-stack reforming also provides a more uniform temperature profile across the fuel cell stack and may eliminate the need for the reformer unit 14.

As will be apparent from the description, some examples of the disclosure may provide for one or more advantages. For example, in some instances, a fuel processing subsystem in accordance with an example of the disclosure may greatly reduce the risk of carbon formation in the fuel cell system by removing higher hydrocarbons which are more easily converted to carbon. Some examples of the system may be particularly advantageous when the fuel cell system operates with in-stack reforming because of the reduced risk of carbon formation at high temperatures in the fuel cell stack. Some examples of the disclosure may allow for the elimination or use of a smaller and less expensive steam reformer unit to be used because at least a portion of the steam reforming can be done in the fuel cell stack. Further, in some examples of this disclosure, the anode recycle stream provides substantially all of the steam needed by the subsystem and there is no requirement to supply steam from an external source. The steam being necessary for: a) higher hydrocarbon reduction, b) methane steam reforming in or external to the fuel cell stack, c) preventing carbon formation in the fuel cell anode loop, and d) heat transfer from the fuel cell stack.

### EXAMPLES

A series of experiments were performed to evaluate one or more aspects related to examples of the present disclosure.

### Example 1

The effectiveness of a catalytic component was demonstrated in a bench-scale test unit. A 0.43″ Diameter×6″ Length ceramic honeycomb (400 cpsi), wash-coated with a catalyst comprising rhodium and platinum, was loaded in a tubular reactor and heated to approximately 678 degrees Celsius.

A simulated anode ejector exit stream at 4 bara was generated by mixing 0.708 SLM of desulfurized natural gas [81.8% CH₄, 8.02% C₂H₆, 0.35% C₃H₈, 0.11% C₄H₁₀, 0.034% C₅H₁₂, 1.27% CO₂ and 8.11% N₂; v-%] with 0.467 SLM of carbon monoxide, 0.708 SLM of hydrogen, 0.906 SLM of carbon dioxide, and 1.982 SLM of steam. The simulated gas feed was preheated to approximately 678 degrees Celsius and then passed over the higher hydrocarbon reduction catalyst with a GHSV of 21,011 h⁻¹.

The composition of the dry reactor effluent was found to be (in v-%) CH₄ 11.3%, CO 14.6%, CO₂ 26.9%, H₂ 39.8% and N₂ 7.5%.

Based on the effluent composition, the higher hydrocarbon reduction catalyst completely removed the higher hydrocarbons from the product stream.

### Example 2

The effect of throughput on the conversion of C₂₊ hydrocarbons was evaluated in a bench-scale test unit. A 0.43″ Diameter×1″ Length ceramic honeycomb (400 cpsi) wash-coated with a catalyst comprising rhodium and platinum, loaded in a tubular reactor and heated to approximately 678 degrees Celsius.

A simulated anode ejector exit stream at 4 bara was generated by mixing desulfurized natural gas [82% CH₄, 7.4% C₂H₆, 0.48% C₃H₈, 0.15% C₄H₁₀, 0.04% C₅H₁₂, 1.41% CO₂ and 8.1% N₂; v-%] with carbon monoxide, hydrogen, carbon dioxide and steam, to give a simulated gas feed comprising 14.2% CH₄, 1.3% C₂H₆, 0.083% C₃H₈, 0.026% C₄H₁₀, 0.006% C₅H₁₂, 7.3% CO, 19.6% CO₂, 13.0% H₂, 3.1% N₂ and 41.4% H₂O (v-%).

The simulated feed was preheated to approximately 678 degrees Celsius and then passed over the higher hydrocarbon reduction catalyst at GHSVs of 38,100-130,400 h⁻¹.

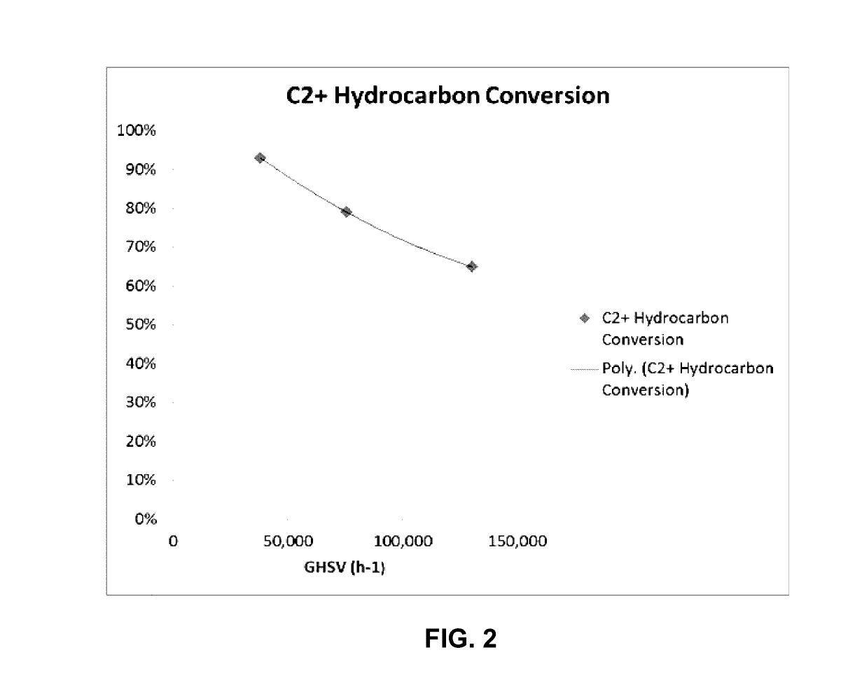

The C₂₊ hydrocarbon conversion data is summarized in the Table 1 below and FIG. 2.

TABLE 1

| GHSV (h⁻¹) | C₂₊ hydrocarbon conversion |
|---|---|
| 38,128 | 93% |
| 75,779 | 79% |
| 130,399 | 65% |

As illustrated by the C₂₊ hydrocarbon conversion data, the higher HC reduction catalyst significantly reduced the level higher hydrocarbons in the product stream even when operating at high throughputs (GHSVs>35,000 h⁻¹).

### Example 3

The effectiveness of a catalytic component for reducing carbon formation was demonstrated in a bench-scale test unit. A 0.43″ Diameter×0.5″ Length ceramic honeycomb (400 cpsi), wash-coated with a catalyst comprising rhodium and platinum, was loaded in a tubular reactor and heated to approximately 785 degrees Celsius.

A simulated anode ejector exit stream at 4 bara was generated by mixing 0.54 SLM of desulfurized natural gas [82.1% CH₄, 7.54% C₂H₆, 0.51% C₃H₈, 0.13% C₄H₁₀, 0.03% C₅H₁₂, 1.5% CO₂ and 7.9% N₂; v-%] with 0.22 SLM of carbon monoxide, 0.39 SLM of hydrogen, 0.58 SLM of carbon dioxide, and 1.244 SLM of steam. The simulated gas feed was preheated to approximately 785 degrees Celsius and then passed over the higher hydrocarbon reduction catalyst for 776 hours with a GHSV of 151,557

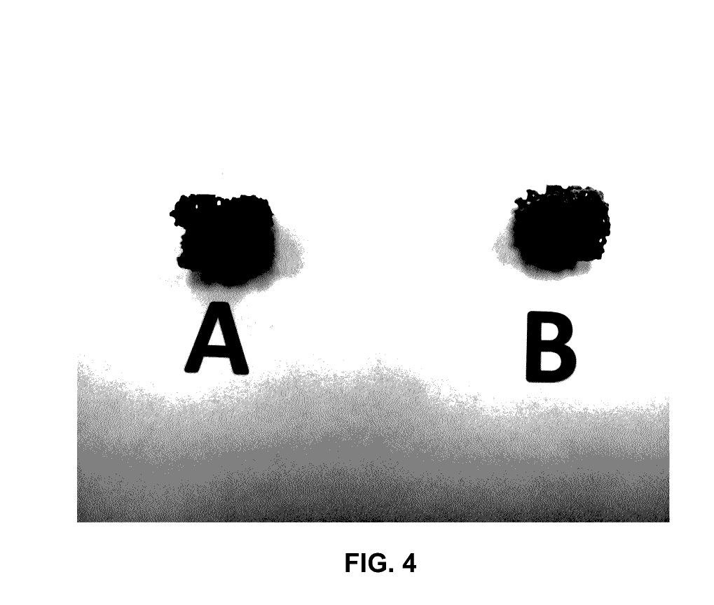

The composition of the dry reactor effluent had an average composition of (in v-%) CH₄ 16.8%, CO 15.1%, CO₂ 27.5%, H₂ 39.8%, N₂ 3.7% and 0.3% C₂₊ hydrocarbons. FIG. 4 is a photograph showing two ceramic test pieces located upstream (A) and downstream (Sample B) of the higher HC reduction catalyst. As shown, the test piece (A) located upstream of the catalyst had significant carbon deposition while the test piece downstream (B) was clean, e.g., had no visible carbon deposition. The test clearly demonstrated the effectiveness of the higher HC reduction catalyst for reducing carbon deposition in the fuel cell system.

Various embodiments of the invention have been described. These and other embodiments are within the scope of the following claims.

1. A solid oxide fuel cell system comprising:
a solid oxide fuel cell including at least one electrochemical cell, a fuel side inlet, a fuel side outlet, an oxidant side inlet and oxidant side outlet;
an ejector including a first ejector inlet, second ejector inlet, and ejector outlet, wherein the ejector is configured to receive a fuel recycle stream from the fuel side outlet of the solid oxide fuel cell via the first ejector inlet, wherein the ejector is configured to receive a primary fuel stream via the second ejector inlet, wherein the ejector is configured such that the flow of the primary fuel stream draws the fuel recycle stream into the ejector via the first ejector inlet, wherein the ejector is configured to mix the fuel recycle stream and primary fuel stream to form a mixed fuel stream including methane and higher hydrocarbons; and
a higher hydrocarbon reduction unit configured to receive the mixed fuel stream from the ejector outlet and remove at least a portion of the higher hydrocarbons of the mixed fuel stream via a catalytic conversion process to form a reduced higher hydrocarbon fuel stream, wherein the fuel side inlet is configured to receive the reduced higher hydrocarbon fuel stream from the reduction unit outlet,
wherein the at least one electrochemical cell is configured to generate electricity from the fuel in the reduced higher hydrocarbon fuel stream via an electrochemical process with a oxidant stream received by the solid oxide fuel cell via the oxidant side inlet, and
wherein the reduced higher hydrocarbon fuel stream forms the fuel recycle stream exiting the solid oxide fuel cell via the fuel side outlet.

2. The fuel cell system of claim 1, wherein steam present in the fuel recycle stream is generated completely within an anode loop cycle of the system with substantially no additional water being added from an external source.

3. The fuel cell system of claim 1, wherein the higher hydrocarbon reduction unit is configured to convert approximately 80 percent or greater of the higher hydrocarbons in the mixed fuel stream.

4. The fuel cell system of claim 1, wherein the higher hydrocarbon reduction unit is configured to convert less than about 20 percent of the methane in the mixed fuel stream.

5. The fuel cell system of claim 1, wherein the higher hydrocarbon reduction unit operates at a temperature of approximately 600 degrees Celsius or greater.

6. The fuel cell system of claim 1, further comprising a steam reformer between the reduction unit outlet and fuel side inlet configured to convert at least portion of remaining methane and higher hydrocarbons to carbon monoxide and hydrogen in the reduced higher hydrocarbon fuel stream prior to the being received via the fuel side inlet.

7. The fuel cell system of claim 1, wherein the fuel recycle stream has a higher temperature than the primary fuel stream such that a temperature of the primary fuel stream is increased in the ejector when mixed with the fuel recycle stream.

8. The fuel cell system of claim 1, wherein the fuel recycle stream includes steam and hydrogen which is present in the mixed fuel stream, and wherein at least a portion of the higher hydrocarbons of the mixed fuel stream are removed catalytically using the steam and hydrogen in the mixed fuel stream.

9. The fuel cell system of claim 1, wherein the mixed fuel stream includes the fuel recycle stream and the primary fuel stream in a ratio equal to or greater than approximately 3:1.

10. The fuel cell system of claim 1, wherein the higher hydrocarbon reduction unit includes one or more catalytic components coated onto a monolithic form over which the mixed fuel stream flows to remove at least the portion of the higher hydrocarbons in the mixed fuel stream.

11. The fuel cell system of claim 1, wherein the monolithic form comprises a ceramic cordierite monolith.

12. The fuel cell system of claim 1, wherein the higher hydrocarbon reduction unit includes a catalytically active component for the catalytic conversion process, wherein the catalytically active component comprises at least one of rhodium or platinum.

13. A method comprising generating electricity via a solid oxide fuel cell system, the fuel cell system comprising:
a solid oxide fuel cell including at least one electrochemical cell, a fuel side inlet, a fuel side outlet, an oxidant side inlet and oxidant side outlet;
an ejector including a first ejector inlet, second ejector inlet, and ejector outlet, wherein the ejector is configured to receive a fuel recycle stream from the fuel side outlet of the solid oxide fuel cell via the first ejector inlet, wherein the ejector is configured to receive a primary fuel stream via the second ejector inlet, wherein the ejector is configured such that the flow of the primary fuel stream draws the fuel recycle stream into the ejector via the first ejector inlet, wherein the ejector is configured to mix the fuel recycle stream and primary fuel stream to form a mixed fuel stream including methane and higher hydrocarbons; and
a higher hydrocarbon reduction unit configured to receive the mixed fuel stream from the ejector outlet and remove at least a portion of the higher hydrocarbons of the mixed fuel stream via a catalytic conversion process to form a reduced higher hydrocarbon fuel stream, wherein the fuel side inlet is configured to receive the reduced higher hydrocarbon fuel stream from a reduction unit outlet,
wherein the at least one electrochemical cell is configured to generate electricity from the hydrogen in the reduced higher hydrocarbon fuel stream via an electrochemical process with a oxidant stream received by the solid oxide fuel cell via the oxidant side inlet, and wherein the reduced higher hydrocarbon fuel stream forms the fuel recycle stream exiting the solid oxide fuel cell via the fuel side outlet.

14. The method of claim 12, wherein steam present in the fuel recycle stream is generated completely within an anode loop cycle of the system with substantially no additional water being added from an external source.

15. The method of claim 12, wherein the higher hydrocarbon reduction unit is configured to convert approximately 80 percent or greater of the higher hydrocarbons in the mixed fuel stream.

16. The method of claim 12, wherein the higher hydrocarbon reduction unit is configured to convert less than about 20 percent of the methane in the mixed fuel stream.

17. The method of claim 12, wherein the higher hydrocarbon reduction unit operates at a temperature of approximately 600 degrees Celsius or greater.

18. The method of claim 12, wherein the fuel cell system further comprises a steam reformer between the reduction unit outlet and fuel side inlet configured to convert at least portion of remaining methane and higher hydrocarbons to carbon monoxide and hydrogen in the reduced higher hydrocarbon fuel stream prior to the being received via the fuel side inlet.

19. The method of claim 12, wherein the fuel recycle stream has a higher temperature than the primary fuel stream such that a temperature of the primary fuel stream is increased in the ejector when mixed with the fuel recycle stream.

20. The method of claim 12, wherein the fuel recycle stream includes steam and hydrogen which is present in the mixed fuel stream, and wherein at least a portion of the higher hydrocarbons of the mixed fuel stream are removed catalytically using the steam and hydrogen in the mixed fuel stream.
